(19) United States
(12) Patent Application Publication
(10) Pub. No.: US 2011/0129642 A1
(43) Pub. Date: Jun. 2, 2011

(54) SURFACE PROTECTIVE SHEET

(75) Inventors: Shou UCHIDA, Osaka (JP); Ryohei SAWAZAKI, Osaka (JP); Keiji HAYASHI, Osaka (JP); Kouhei TAKEDA, Osaka (JP)

(73) Assignee: NITTO DENKO CORPORATION, Osaka (JP)

(21) Appl. No.: 12/956,057

(22) Filed: Nov. 30, 2010

(30) Foreign Application Priority Data
Dec. 1, 2009 (JP) 2009-273107

(51) Int. Cl. C09J 7/02; B32B 27/32

(52) U.S. Cl. 428/141; 428/354; 428/336

(57) ABSTRACT

Provided is a novel surface protective sheet including a pressure-sensitive adhesive layer on a supporting base material, in which the pressure-sensitive adhesive layer has a high anchoring force for the supporting base material, and no adhesive residue occurs upon peeling of the surface protective sheet after its attachment to an adherend. The surface protective sheet of the present invention is a surface protective sheet including: a supporting base material; a surface layer (I) as one outermost layer of the supporting base material; and a pressure-sensitive adhesive layer on the surface layer (I), in which: the pressure-sensitive adhesive layer contains a thermoplastic elastomer; and the surface layer (I) contains a random polypropylene at a content of more than 50 wt %.

### BACKGROUND OF THE INVENTION

1. Field of the Invention

The present invention relates to a surface protective sheet.

2. Description of the Related Art

Surface protective sheets are used for, for example, protecting adherends such as a metal plate, a resin plate, and a glass plate by being attached to the adherends.

Properties requested of each of the surface protective sheets are, for example, as described below. An adherend is not flawed upon processing or conveyance after the attachment of the surface protective sheet to the adherend. The surface protective sheet neither floats nor peels upon attachment to the adherend. The pressure-sensitive adhesive layer of the surface protective sheet has a high anchoring force for a supporting base material. No adhesive residue occurs upon peeling of the surface protective sheet after its attachment to the adherend.

In general, a natural rubber-based pressure-sensitive adhesive obtained by compounding a natural rubber or modified natural rubber with a tackifier or the like has been conventionally used as a pressure-sensitive adhesive that can be used in the pressure-sensitive adhesive layer of a surface protective sheet. However, the natural rubber-based pressure-sensitive adhesive often involves the emergence of an adhesive residue upon peeling of the surface protective sheet after its attachment to an adherend because of, for example, poor weatherability of the pressure-sensitive adhesive.

In view of the foregoing, a styrene-based thermoplastic elastomer has been proposed as a pressure-sensitive adhesive that can suppress the occurrence of an adhesive residue upon peeling of a surface protective sheet after its attachment to an adherend (Japanese Patent Application Laid-open No. Hei 8-12956, Japanese Patent Application Laid-open No. Hei 9-104848, Japanese Patent Application Laid-open No. Hei 5-194923, and Japanese Patent Application Laid-open No. 2003-119435).

However, a pressure-sensitive adhesive layer containing the styrene-based thermoplastic elastomer has the following inconvenience. That is, the pressure-sensitive adhesive layer has an insufficient anchoring force for a conventional supporting base material. The occurrence of the adhesive residue upon peeling after the attachment to the adherend cannot eventually be suppressed owing to the insufficient anchoring force.

### SUMMARY OF THE INVENTION

The present invention has been made to solve the above-mentioned conventional problems, and an object of the present invention is to provide a novel surface protective sheet including a pressure-sensitive adhesive layer on a supporting base material, in which the pressure-sensitive adhesive layer has a high anchoring force for the supporting base material, and no adhesive residue occurs upon peeling of the surface protective sheet after its attachment to an adherend.

The surface protective sheet of the present invention is a surface protective sheet including: a supporting base material; a surface layer (I) as one outermost layer of the supporting base material; and a pressure-sensitive adhesive layer on the surface layer (I), in which: the pressure-sensitive adhesive layer contains a thermoplastic elastomer; and the surface layer (I) contains a random polypropylene at a content of more than 50 wt %.

According to a preferred embodiment, the above-mentioned surface layer (I) has an arithmetic average surface roughness Ra1 of 0.5 μm or less.

According to a preferred embodiment, the above-mentioned supporting base material is formed of a structure having two or more layers, and has a surface layer (II) having an arithmetic average surface roughness Ra2 of 0.5 μm to 2.0 μm as an outermost layer on the side opposite to the above-mentioned surface layer (I).

According to a preferred embodiment, the above-mentioned supporting base material is formed of a structure having three or more layers, and has a mechanical property control layer as one intermediate layer.

According to a preferred embodiment, the above-mentioned surface layer (I) has a thickness of 2 μm to 20 μm.

According to a preferred embodiment, the above-mentioned surface layer (II) has a thickness of 2 μm to 20 μm.

According to a preferred embodiment, the content of the thermoplastic elastomer in the above-mentioned pressure-sensitive adhesive layer is 50 wt % or more.

According to a preferred embodiment, the random polypropylene in the above-mentioned surface layer (I) has a melt flow rate of 1 g/10 min to 50 g/10 min.

According to a preferred embodiment, the surface protective sheet of the present invention has a haze value of 20% to 80%.

According to the present invention, there can be provided a novel surface protective sheet including a pressure-sensitive adhesive layer on a supporting base material, in which the pressure-sensitive adhesive layer has a high anchoring force for the supporting base material, and no adhesive residue occurs upon peeling of the surface protective sheet after its attachment to an adherend.

### BRIEF DESCRIPTION OF THE DRAWINGS

FIG. 1 is a schematic sectional view of a surface protective sheet according to a preferred embodiment of the present invention.

### DETAILED DESCRIPTION OF THE PREFERRED EMBODIMENTS

### A. Entire Constitution of Surface Protective Sheet

A surface protective sheet of the present invention includes a supporting base material and a pressure-sensitive adhesive layer. The supporting base material has a surface layer (I) as one outermost layer. The pressure-sensitive adhesive layer is provided on the surface layer (I).

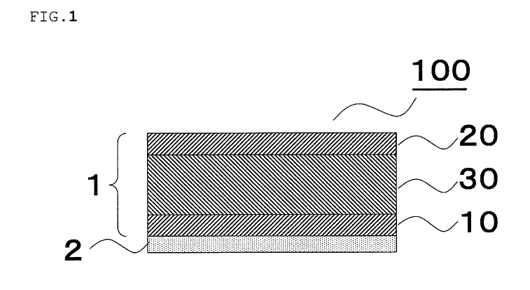

FIG. 1 is a schematic sectional view of a surface protective sheet according to a preferred embodiment of the present invention. A surface protective sheet 100 includes a supporting base material 1 and a pressure-sensitive adhesive layer 2. The supporting base material 1 has a surface layer (I) 10 as one outermost layer. It is preferred that the supporting base material 1 have a surface layer (II) 20 as an outermost layer on the side opposite to the surface layer (I) 10 and have a mechanical property control layer 30 as an intermediate layer as illustrated in FIG. 1. The surface protective sheet of the present invention is not limited to the specific mode illustrated in FIG. 1, and for example, may have a plurality of intermediate layers or may be free of any intermediate layer. In addition, the supporting base material may be formed of a structure having two or more layers, or may be formed of a structure having three or more layers.

The total thickness of the surface protective sheet of the present invention can be set to any appropriate thickness depending on applications. The total thickness is preferably 10 μm to 200 μm, more preferably 15 μm to 150 μm, still more preferably 20 μm to 100 μm.

The surface protective sheet of the present invention has a haze value of preferably 20% to 80%, more preferably 30% to 75%. As long as the haze value of the surface protective sheet falls within such range, the surface protective sheet has an external appearance suitable for an external appearance-adjusting application. An external appearance adjustment can impart functions such as the sliding property of a squeegee, air bubble leakage property, air bubble visibility, an upscale image, and surface protective material visibility (the ease with which to find that the surface protective sheet is attached).

### B. Supporting Base Material

The supporting base material has the surface layer (I) as one outermost layer. The supporting base material preferably has the surface layer (II) as the outermost layer on the side opposite to the surface layer (I). In addition, the supporting base material preferably has the mechanical property control layer as an intermediate layer. Hereinafter, the mechanical property control layer (intermediate layer that can be appropriately constituted), the surface layer (I), the surface layer (II) (layer that is appropriately constituted), and any other layer (layer that is appropriately constituted) are sequentially described.

### B-1. Mechanical Property Control Layer

The mechanical property control layer is appropriately selected so that desired mechanical properties may be expressed in the supporting base material. Any appropriate thickness can be adopted as the thickness of the mechanical property control layer depending on applications. The thickness of the mechanical property control layer is preferably 10 μm to 150 μm, more preferably 20 μm to 100 μm.

Any appropriate material can be adopted for the mechanical property control layer. The layer preferably contains a thermoplastic resin.

Any appropriate resin can be adopted as the above-mentioned thermoplastic resin as long as film forming by melt extrusion can be performed. Examples of the thermoplastic resin include: polyolefin resins such as a propylene-based polymer, a polyethylene, and an olefin-based thermoplastic elastomer (TPO) and modified products thereof; α-olefin-vinyl compound (such as vinyl acetate and (meth)acrylic acid ester) copolymers; polyamides; polyesters; polycarbonates; polyurethanes; and polyvinyl chlorides. Examples of the propylene-based polymer include a homopolypropylene, a block polypropylene, and a random polypropylene.

When a homopolypropylene is used as the above-mentioned thermoplastic resin, the structure of the homopolypropylene may be any one of an isotactic structure, an atactic structure, and a syndiotactic structure.

When a polyethylene is used as the above-mentioned thermoplastic resin, the polyethylene may be anyone of a low-density polyethylene, a medium-density polyethylene, and a high-density polyethylene.

In the mechanical property control layer, the above-mentioned thermoplastic resins may be incorporated alone, or in combination. Examples of a form in which two or more kinds of the resins are incorporated in combination include a form in which the resins are blended and a form in which the resins are copolymerized.

A commercially available product may be used as the above-mentioned thermoplastic resin. Specific examples of the commercially available thermoplastic resin include a series of products available under the trade name “Sumitomo Noblen” from Sumitomo Chemical Co., Ltd., series of products available under the trade names “PF”, “PM”, “PC”, and “PB” (block polypropylenes) from SunAllomer Ltd.

The mechanical property control layer can contain any appropriate additive as required. Examples of the additive that can be incorporated into the mechanical property control layer include a UV absorbing agent, a thermal stabilizer, a filler, and a lubricant. The kinds, number, and amount of additives to be incorporated into the mechanical property control layer can be appropriately set depending on purposes.

Examples of the above-mentioned UV absorbing agent include a benzotriazole-based compound, a benzophenone-based compound, and a benzoate-based compound. Any appropriate content can be adopted as the content of the above-mentioned UV absorbing agent as long as the agent does not bleed out at the time of the forming of the surface protective sheet. The content is representatively 0.01 part by weight to 5 parts by weight with respect to 100 parts by weight of the thermoplastic resin in the mechanical property control layer.

Examples of the above-mentioned thermal stabilizer include a hindered amine-based compound, a phosphorus-based compound, and a cyanoacrylate-based compound. Any appropriate content can be adopted as the content of the above-mentioned thermal stabilizer as long as the stabilizer does not bleed out at the time of the forming of the surface protective sheet. The content is representatively 0.01 part by weight to 5 parts by weight with respect to 100 parts by weight of the thermoplastic resin in the mechanical property control layer.

Examples of the above-mentioned filler include inorganic fillers such as talc, titanium oxide, calcium carbonate, clay, mica, barium sulfate, whisker, and magnesium hydroxide. The filler preferably has an average particle diameter of 0.1 μm to 10 μm. The content of the filler is preferably 1 part by weight to 200 parts by weight with respect to 100 parts by weight of the thermoplastic resin in the mechanical property control layer.

### B-2. Surface Layer (I)

The surface layer (I) has a thickness of preferably 2 μm to 20 μm, more preferably 2 μm to 15 μm, particularly preferably 2 μm to 10 μm. As long as the thickness of the surface layer (I) falls within such range as described above, lamination with a uniform thickness can be performed, formability and handleability are improved, the anchoring force of the pressure-sensitive adhesive layer for the surface layer (I) can be sufficiently expressed, and the mechanical properties of the entirety of the surface protective sheet of the present invention are also improved.

The thickness of the surface layer (I) is preferably equal to or less than the thickness of the mechanical property control layer, more preferably 80% or less of the thickness of the mechanical property control layer, still more preferably 50% or less of the thickness of the mechanical property control layer. As long as the thickness of the surface layer (I) falls within such range, the mechanical properties of the surface layer (I), the mechanical properties of the entirety of the surface protective sheet of the present invention, and the handleability of the surface protective sheet of the present invention are improved.

The surface layer (I) has an arithmetic average surface roughness Ra1 of preferably 0.5 μm or less, more preferably 0.45 μm or less, still more preferably 0.35 μm or less, still more preferably 0.30 μm or less, particularly preferably 0.25 μm or less, particularly preferably 0.20 μm or less, most preferably 0.15 μm or less. A lower limit for the arithmetic average surface roughness Ra1 of the surface layer (I) described above is preferably 0.01 μm or more.

As long as the arithmetic average surface roughness Ra1 of the surface layer (I) falls within such range as described above, the pressure-sensitive adhesive layer has an increased anchoring force for the supporting base material in the resultant surface protective sheet, and the occurrence of an adhesive residue upon peeling of the surface protective sheet after its attachment to an adherend can be suppressed to an additionally large extent.

The surface layer (I) contains a random polypropylene at a content of more than 50 wt %. The content of the random polypropylene in the surface layer (I) is preferably 60 wt % to 100 wt %, more preferably 70 wt % to 100 wt %, still more preferably 80 wt % to 100 wt %, particularly preferably 90 wt % to 100 wt %, most preferably 95 wt % to 100 wt %. Setting the content of the random polypropylene in the surface layer (I) within the above-mentioned range allows the pressure-sensitive adhesive layer to have a high anchoring force for the supporting base material in the resultant surface protective sheet and prevents the occurrence of an adhesive residue upon peeling of the surface protective sheet after its attachment to an adherend.

Any appropriate random polypropylene can be adopted as the above-mentioned random polypropylene. Examples of the random polypropylene include a random polypropylene produced using a Ziegler-Natta catalyst and a random polypropylene produced using a metallocene catalyst. A random polypropylene produced using a metallocene catalyst is preferred in terms of quality, physical properties, and the like.

A commercially available product may be used as the above-mentioned random polypropylene. Specific examples of the commercially available random polypropylene include a series of products available under the trade name “NOVATEC PP” (random polypropylenes produced through the use of a Ziegler-Natta catalyst) from Japan Polypropylene Corporation, series of products available under the trade names “WINTEC” and “WELNEX” (random polypropylenes produced through the use of a metallocene catalyst) from Japan Polypropylene Corporation, and series of products available under the trade names “PF”, “PC”, “PM”, “PB”, “PS”, and “PH” from SunAllomer Ltd.

The random polypropylene in the surface layer (I) has a melt flow rate of preferably 1 g/10 min to 50 g/10 min, more preferably 1.5 g/10 min to 40 g/10 min, still more preferably 2.0 g/10 min to 30 g/10 min. As long as the melt flow rate of the random polypropylene in the surface layer (I) falls within such range, the pressure-sensitive adhesive layer has an increased anchoring force for the supporting base material in the resultant surface protective sheet, and the occurrence of an adhesive residue upon peeling of the surface protective sheet after its attachment to an adherend can be suppressed to an additionally large extent. In addition, as long as the melt flow rate of the random polypropylene in the surface layer (I) falls within such range, productivity is improved. When the melt flow rate falls short of such range, an extrusion amount at the same temperature and the same pressure reduces, thereby leading to a reduction in productivity (an increase in cost or a reduction in film formability). The melt flow rate can be measured by a method in conformity with JIS K7210.

The surface layer (I) may contain only one kind of a random polypropylene, or may contain two or more kinds of random polypropylenes in combination.

The surface layer (I) may contain any appropriate resin component except the random polypropylene to such an extent that an effect of the present invention is not impaired. Examples of the resin component include a low-density polyethylene, a linear, low-density polyethylene, a high-density polyethylene, a homopolypropylene, a block polypropylene, an ethylene-α-olefin copolymer, a propylene-α-olefin copolymer, and an ethylene-propylene copolymer.

The surface layer (I) can contain any appropriate additive as required. For example, any one of the additives described in the section B-1 can be used as the additive that can be incorporated into the surface layer (I).

### B-3. Surface Layer (II)

The surface layer (II) has a thickness of preferably 2 μm to 20 μm, more preferably 2 μm to 15 μm, particularly preferably 2 μm to 10 μm. As long as the thickness of the surface layer (II) falls within such range as described above, desired surface roughness and a desired haze value are easily obtained, the mechanical properties of the entirety of the surface protective sheet of the present invention are improved, and the handleability of the surface protective sheet of the present invention is improved.

The thickness of the surface layer (II) is preferably equal to or less than the thickness of the mechanical property control layer, more preferably 80% or less of the thickness of the mechanical property control layer, still more preferably 50% or less of the thickness of the mechanical property control layer. As long as the thickness of the surface layer (II) falls within such range, the mechanical properties of the surface layer (II), the mechanical properties of the entirety of the surface protective sheet of the present invention, and the handleability of the surface protective sheet of the present invention are improved.

The surface layer (II) has an arithmetic average surface roughness Ra2 of 0.5 μm to 2.0 μm, preferably 0.8 μm to 1.9 μm, more preferably 1.0 μm to 1.9 μm.

As long as the arithmetic average surface roughness Ra2 of the surface layer (II) falls within such range as described above, a surface protective sheet having an external appearance suitable for an external appearance-adjusting application can be obtained.

The surface layer (II) may be formed of any appropriate material as long as the material is such that the arithmetic average surface roughness Ra2 is 0.5 μm to 2.0 μm. Any one of the following forms A to C can be preferably adopted as the surface layer (II).

The surface layer (II) preferably contains a polyethylene and a propylene-based polymer (form A).

As the propylene-based polymer, any appropriate propylene-based polymer can be adopted, for example. Specific examples of the propylene-based polymer include a homopolypropylene, a block polypropylene, and a random polypropylene. Alternatively, a polypropylene obtained through the use of a metallocene catalyst may be used as the propylene-based polymer.

Commercially available products may be used as the polyethylene and the propylene-based polymer described above.

Specific examples of the commercially available polyethylene include a product available under the trade name “Petrocene 209” from TOSOH CORPORATION, and products available under the trade names “NOVATEC LD LJ803”, “NOVATEC LD LC701”, and “NOVATEC LD LC720” from Japan Polyethylene Corporation.

Specific examples of the commercially available propylene-based polymer include a series of products available under the trade name “Sumitomo Nobrene” from Sumitomo Chemical Company, Limited, a series of products available under the trade name “NOVATEC PP” from Japan Polypropylene Corporation, series of products available under the trade names “WINTEC” and “WELNEX” from Japan Polypropylene Corporation, and series of products available under the trade names “PF”, “PC”, “PM”, “PB”, “PS”, and “PH” from SunAllomer Ltd.

Any appropriate weight ratio can be adopted as a weight ratio between the polyethylene and the propylene-based polymer described above depending on a desired haze value and/or desired surface roughness. The weight ratio (polyethylene:propylene-based polymer) is preferably 10:90 to 90:10, more preferably 20:80 to 80:20, particularly preferably 30:70 to 70:30.

The surface layer (II) preferably includes a propylene-based polymer and an olefin-based thermoplastic elastomer (form B).

As the propylene-based polymer, the propylene-based polymer described in the form A can be used, for example.

Any appropriate olefin-based thermoplastic elastomer can be adopted as the olefin-based thermoplastic elastomer as long as the olefin-based thermoplastic elastomer is what is so called TPO. The olefin-based thermoplastic elastomer typically has a hard segment portion formed of a polyethylene or polypropylene and a soft segment portion that is a rubber component (a hydrogenated (styrene) butadiene rubber or an ethylene-propylene rubber (such as an EPDM, EPM, or EBM)).

Commercially available products may be used as the propylene-based polymer and the olefin-based thermoplastic elastomer described above.

Specific examples of the commercially available propylene-based polymer include the commercially available propylene-based polymers described in the form A.

The commercially available olefin-based thermoplastic elastomer is specifically, for example, a series of products available under the trade name “Catalloy” from SunAllomer Ltd.

Any appropriate weight ratio can be adopted as a weight ratio between the propylene-based polymer and the olefin-based thermoplastic elastomer described above depending on a desired haze value and/or desired surface roughness. The weight ratio (propylene-based polymer: olefin-based thermoplastic elastomer) is preferably 20:80 to 80:20, more preferably 30:70 to 70:30, particularly preferably 40:60 to 60:40.

The surface layer (II) preferably contains a polyethylene and an ethylene-vinyl acetate copolymer (form C).

Commercially available products may be used as the polyethylene and the ethylene-vinyl acetate copolymer described above.

Specific examples of the commercially available polyethylene include the commercially available polyethylenes described in the form A.

The commercially available ethylene-vinyl acetate copolymer is specifically, for example, an “EVAFLEX” series manufactured by DU PONT-MITSUI POLYCHEMICALS CO., LTD.

Any appropriate weight ratio can be adopted as a weight ratio between the polyethylene and the ethylene-vinyl acetate copolymer described above depending on a desired haze value and/or desired surface roughness. The weight ratio (polyethylene:ethylene-vinyl acetate copolymer) is preferably 20:80 to 80:20, more preferably 30:70 to 80:20, particularly preferably 30:70 to 70:30.

The various resin components in the surface layer (II) may be used alone or in combination.

The surface layer (II) may contain any appropriate resin component except the resins described in the above-mentioned forms A to C to such an extent that an effect of the present invention is not impaired.

The surface layer (II) may contain a long-chain alkyl-based releasing agent. When the surface layer (II) contains the long-chain alkyl-based releasing agent, the attachment of the surface layer (II) and the pressure-sensitive adhesive layer in a state in which portions of a pressure-sensitive adhesive tape overlap each other such as storage in a roll shape can be prevented. In addition, there is no need to cover the surface layer (II) with a separator layer, and hence a pressure-sensitive adhesive tape having a desired haze value and desired surface roughness can be easily obtained.

The long-chain alkyl-based releasing agent contains a long-chain alkyl-based polymer. The long-chain alkyl-based polymer can be obtained by causing a polymer having a reactive group and a compound having an alkyl group capable of reacting with the reactive group to react with each other in any appropriate heated solvent. A catalyst may be used as required at the time of the reaction. Examples of the catalyst include a tin compound and a tertiary amine.

Examples of the above-mentioned reactive group include a hydroxyl group, an amino group, a carboxyl group, and a maleic anhydride group. Examples of a polymer having the reactive group include an ethylene-vinyl alcohol copolymer, polyvinyl alcohol, polyethylenimine, polyethylenamine, a styrene-maleic anhydride copolymer. Of those, an ethylene-vinyl alcohol copolymer is preferred. It should be noted that the term “ethylene-vinyl alcohol copolymer” also includes a partially saponified product of ethylene-vinyl acetate copolymer. The term “polyvinyl alcohol” also includes a partially saponified product of polyvinyl acetate.

The number of carbon atoms of the above-mentioned alkyl group is preferably 8 to 30, more preferably 12 to 22. When the number of carbon atoms of the above-mentioned alkyl group falls within such range, a surface layer (II) having excellent peeling property can be obtained. Specific examples of such alkyl group include a lauryl group, a stearyl group, and a behenyl group. Examples of a compound having such alkyl group (that is, compound having an alkyl group capable of reacting with the above-mentioned reactive group) include: isocyanates such as octyl isocyanate, decyl isocyanate, lauryl isocyanate, and stearyl isocyanate; acid chlorides; amines; and alcohols. Of those, isocyanates are preferred.

The long-chain alkyl-based polymer has a weight-average molecular weight of preferably 10,000 to 1,000,000, more preferably 20,000 to 1,000,000. When the weight-average molecular weight of the long-chain alkyl-based polymer falls within such range, a surface layer (II) having excellent peeling property can be obtained.

The content of the long-chain alkyl-based releasing agent in the surface layer (II) is preferably 1 wt % to 50 wt %, more preferably 2 wt % to 30 wt %, particularly preferably 5 wt % to 20 wt %. When the content is smaller than 1 wt %, an effect of the addition of the long-chain alkyl-based releasing agent may not be obtained. When the content is larger than 50 wt %, a bleed product may be produced.

The surface layer (II) can contain any appropriate additive as required. For example, any one of the additives described in the section B-1 can be used as the additive that can be incorporated into the surface layer (II).

### B-4. Other Layer

The surface protective sheet of the present invention may further have any appropriate other layer as required (not shown). The surface protective sheet can have the other layer as a layer except the surface layer (I) as one outermost layer in the supporting base material.

### C. Pressure-Sensitive Adhesive Layer

The pressure-sensitive adhesive layer has a thickness of preferably 1 μm to 300 μm, more preferably 2 μm to 100 μm, particularly preferably 3 μm to 50 μm.

Any appropriate value can be adopted as the haze value of the pressure-sensitive adhesive layer as long as the haze value of the surface protective sheet of the present invention is 20% to 80%. The haze value of the pressure-sensitive adhesive layer is preferably 1% to 80%, more preferably 10% to 60%. When the haze value of the pressure-sensitive adhesive layer falls within such range, a surface protective sheet having an external appearance suitable for an external appearance-adjusting application can be obtained.

The pressure-sensitive adhesive layer contains a thermoplastic elastomer. The content of the thermoplastic elastomer in the pressure-sensitive adhesive layer is preferably 50 wt % to 100 wt %, more preferably 50 wt % to 95 wt %, still more preferably 50 wt % to 90 wt %. When the content of the thermoplastic elastomer in the pressure-sensitive adhesive layer falls within the above-mentioned range, the resultant surface protective sheet is sufficiently bonded to an adherend, the pressure-sensitive adhesive layer has an increased anchoring force for the supporting base material, and the occurrence of an adhesive residue upon peeling of the surface protective sheet after its attachment to the adherend can be suppressed to an additionally large extent.

Any appropriate thermoplastic elastomer can be adopted as the thermoplastic elastomer. Examples of the thermoplastic elastomer include a styrene-based thermoplastic elastomer, an olefin-based thermoplastic elastomer, a vinyl chloride-based thermoplastic elastomer, a urethane-based thermoplastic elastomer, a polyester-based thermoplastic elastomer, and a polyamide-based thermoplastic elastomer. The thermoplastic elastomers may be used alone or in combination.

The above-mentioned thermoplastic elastomer is preferably a styrene-based thermoplastic elastomer. Examples of the styrene-based thermoplastic elastomer include: styrene-based AB-type diblock copolymers such as a styrene-ethylene-butylene copolymer (SEB); styrene-based ABA-type triblock copolymers such as a styrene-butadiene-styrene copolymer (SBS), a hydrogenated product of SBS (styrene-ethylene-butylene-styrene copolymer (SEBS)), a styrene-isoprene-styrene copolymer (SIS), a hydrogenated product of SIS (styrene-ethylene-propylene-styrene copolymer (SEPS)), a styrene-isobutylene-styrene copolymer (SIBS); styrene-based ABAB-type tetrablock copolymers such as styrene-butadiene-styrene-butadiene (SBSB); styrene-based ABABA-type pentablock copolymers such as styrene-butadiene-styrene-butadiene styrene (SBSBS); styrene-based multi-block copolymers having six or more of A-B repeat units; and hydrogenated products each obtained by hydrogenating ethylenic double bonds of a styrene-based random copolymer such as a styrene-butadiene rubber (SBR). A commercially available product may also be used as the styrene-based thermoplastic elastomer.

As the commercially available styrene-based thermoplastic elastomer, there is specifically given a “G1657” (styrene-based elastomer) manufactured by Kraton Polymers, for example.

As the thermoplastic elastomer other than the styrene-based thermoplastic elastomer, there are specifically given a CEBC (Dynaron 6000 series manufactured by JSR Corporation), and an SEBC (Dynaron 4000 series manufactured by JSR Corporation), for example.

The pressure-sensitive adhesive layer may include any appropriate pressure-sensitive adhesive other than the styrene-based thermoplastic elastomer. As such pressure-sensitive adhesive, there are given a rubber-based pressure sensitive adhesive, an acrylic pressure-sensitive adhesive, and a silicone-based pressure-sensitive adhesive, for example.

The pressure-sensitive adhesive layer can contain any other component as required. Examples of the other component include: an olefin-based resin; a silicone-based resin; a liquid acrylic copolymer; a polyethyleneimine; a fatty acid amide; a phosphate; and a general additive. The kinds, number, and amount of other components to be incorporated into the pressure-sensitive adhesive layer can be appropriately set depending on purposes. Examples of the additive include: a tackifier; a softening agent; an antioxidant; a hindered amine-based light stabilizer; a UV absorbing agent; and a filler or pigment such as calcium oxide, magnesium oxide, silica, zinc oxide, or titanium oxide.

The compounding of the tackifier is effective in improving an adhesive strength. The compounding amount of the tackifier is suitably determined to be any appropriate compounding amount depending on an adherend in order that the emergence of an adhesive residue problem due to a reduction in cohesive strength may be avoided. In ordinary cases, the amount is preferably 0 to 60 parts by weight, more preferably 0 to 50 parts by weight, still more preferably 0 to 40 parts by weight with respect to 100 parts by weight of the resin material for forming the pressure-sensitive adhesive.

Examples of the tackifier include: petroleum-based resins such as an aliphatic copolymer, an aromatic copolymer, an aliphatic/aromatic copolymer system, and an alicyclic copolymer; coumarone-indene-based resins; terpene-based resins; terpene phenol-based resins; rosin-based resins such as polymerized rosin; (alkyl) phenol-based resins; xylene-based resins; and hydrogenated products of the resins. The tackifiers may be used alone or in combination.

A hydrogenated tackifier such as an “ARKON P-125” manufactured by Arakawa Chemical Industries, Ltd. is preferably used as the tackifier in terms of, for example, peeling property and weatherability. It should be noted that a product commercially available as a blend with an olefin resin or thermoplastic elastomer can also be used as the tackifier.

The compounding of the softening agent is effective in improving the adhesive strength. Examples of the softening agent include a low-molecular-weight diene-based polymer, a polyisobutylene, a hydrogenated polyisoprene, a hydrogenated polybutadiene, and derivatives of them. Examples of the derivatives include those each having an OH group or COOH group on one of, or each of both of, its terminals. Specific examples of such derivatives include a hydrogenated polybutadiene diol, a hydrogenated polybutadiene monool, a hydrogenated polyisoprene diol, and a hydrogenated polyisoprene monool. A hydrogenated product of a diene-based polymer such as a hydrogenated polybutadiene or a hydrogenated polyisoprene, an olefin-based softening agent, or the like is preferred in order that a rise in adhesion for the adherend may be additionally suppressed. To be specific, a “Kuraprene LIR-200” manufactured by KURARAY CO., LTD. is exemplified. Those softening agents may be used alone or in combination.

The molecular weight of the softening agent can be suitably set to any appropriate value. When the molecular weight of the softening agent is excessively small, the small molecular weight may cause, for example, the transfer of a substance from the pressure-sensitive adhesive layer to the adherend or heavy peeling. On the other hand, when the molecular weight of the softening agent is excessively large, an improving effect on the adhesive strength tends to be poor. Accordingly, the number-average molecular weight of the softening agent is preferably 5000 to 100,000, more preferably 10,000 to 50,000.

When the softening agent is used, any appropriate amount can be adopted as its addition amount. When the addition amount of the softening agent is excessively large, the amount of an adhesive residue at the time of exposure to high temperatures or outdoors tends to increase. Accordingly, the addition amount is preferably 40 parts by weight or less, more preferably 20 parts by weight or less, still more preferably 10 parts by weight or less with respect to 100 parts by weight of the resin material for forming the pressure-sensitive adhesive. When the addition amount of the softening agent exceeds 40 parts by weight with respect to 100 parts by weight of the resin material for forming the pressure-sensitive adhesive, the adhesive residue under a high-temperature environment or under exposure to outdoors becomes remarkable.

One, or each of both, of the surfaces of the pressure-sensitive adhesive layer may be subjected to a surface treatment as required. Examples of the surface treatment include a corona discharge treatment, a UV irradiation treatment, a flame treatment, a plasma treatment, and a sputter etching treatment.

### D. Method of Producing Surface Protective Sheet

The surface protective sheet of the present invention can be produced by any appropriate method. Representative examples of the method include: a method involving producing the supporting base material by co-extrusion and performing hot melt application of a pressure-sensitive adhesive onto the supporting base material (production method 1); a method involving producing the supporting base material by co-extrusion and applying an organic solvent application liquid in which the pressure-sensitive adhesive is dissolved or an emulsion liquid in which the pressure-sensitive adhesive is water-dispersed onto the supporting base material (production method 2); and a method involving subjecting a material for forming each layer of the supporting base material and a material for forming the pressure-sensitive adhesive layer to co-extrusion (production method 3).

A method for the co-extrusion can be performed with an extruder and a co-extrusion die in conformity with, for example, an inflation method or a T-die method.

When the surface protective sheet of the present invention is produced by the above-mentioned production method 1 or 2, the surface of the supporting material on which the pressure-sensitive adhesive layer is formed, that is, the surface of the surface layer (I) may be subjected to an easy-adhesion treatment. Examples of the easy-adhesion treatment include a corona discharge treatment, an ITRO treatment (silicification flame treatment), and an anchor coat treatment.

Any appropriate organic solvent can be adopted as the organic solvent in the above-mentioned production method 2. Examples of the organic solvent include: aromatic hydrocarbon-based solvents such as toluene and xylene; aliphatic carboxylate-based solvents such as ethyl acetate; and aliphatic hydrocarbon-based solvents such as hexane, heptane, and octane. The organic solvents may be used alone or in combination.

When the surface protective sheet of the present invention is produced by the above-mentioned production method 2, a cross-linking agent may be incorporated into the organic solvent application liquid. Examples of the cross-linking agent include an epoxy-based cross-linking agent, an isocyanate-based cross-linking agent, and an aziridine cross-linking agent.

Any appropriate application method can be adopted as an application method when the surface protective sheet of the present invention is produced by the above-mentioned production method 2. Examples of the application method include methods each involving the use of a bar coater, a gravure coater, a spin coater, a roll coater, a knife coater, or an applicator.

A releasing agent may be incorporated into the surface protective sheet of the present invention. Examples of the releasing agent include a long-chain alkyl-based releasing agent and a silicone-based releasing agent. A method of incorporating the releasing agent into the surface protective sheet of the present invention is, for example, a method involving incorporating the releasing agent into the surface layer (II) and subjecting the resultant to co-extrusion in any one of the above-mentioned production methods 1 to 3, or a method involving dissolving the releasing agent in a solvent or the like after the formation of the supporting base material and applying the solution in any one of the above-mentioned production methods 1 to 3.

Hereinafter, the present invention is specifically described by way of examples. However, the present invention is by no means limited by these examples. It should be noted that, in the examples and the like, test and evaluation methods are as described below, and the term “part(s)” means “part(s) by weight.”

### <<Arithmetic Average Surface Roughness Ra1>>

After the surface of the surface layer (II) out of contact with the pressure-sensitive adhesive layer of the supporting base material had been attached to a slide glass with a double faced tape, the surface of the surface layer (I) in contact with the pressure-sensitive adhesive layer of the supporting base material was measured with an optical profiler NT9100 (manufactured by Veeco) under the conditions “Measurement Type: VSI (Infinite Scan), Objective: 10.0×, FOV: 1.0×, Modulation Threshold: 0.1%” for n=3. After the measurement, data analysis was performed under the conditions “Terms Removal: Tilt Only (Plane Fit), Window Filtering: Fourier Filtering, Fourier Filtering (High Pass/Gaussian/High Out Off 5/mm)” Thus, the arithmetic average surface roughness Ra which was recorded upon performing the data analysis was determined as Ra1.

### <<Arithmetic Average Surface Roughness Ra2>>

After the surface of the surface layer (I) in contact with the pressure-sensitive adhesive layer of the supporting base material had been attached to a slide glass with a double faced tape, the surface of the surface layer (II) out of contact with the pressure-sensitive adhesive layer of the supporting base material was measured with the optical profiler NT9100 (manufactured by Veeco) under the conditions “Measurement Type: VSI (Infinite Scan), Objective: 2.5×, FOV: 1.0×, Modulation Threshold: 0.1%” for n=3. After the measurement, data analysis was performed under the conditions “Terms Removal: Tilt Only (Plane Fit), Window Filtering: None.” Thus, the arithmetic average surface roughness Ra which was recorded upon performing the data analysis was determined as Ra2.

### <<Haze>>

Measurement was performed with a HAZEMETER HM-150 (manufactured by Murakami Color Research Laboratory Co., Ltd.). The haze was calculated in conformity with JIS K7136 from the equation “haze (%)=Td/Ttx100 (Td: diffuse transmittance, Tt: total light transmittance).”

### <<Anchoring Force>>

The surfaces of the pressure-sensitive adhesive layers of surface protective sheets were attached to each other at a linear pressure of 78.5 N/cm and a speed of 300 mm/min, and then the surface on the side opposite to the surfaces of the pressure-sensitive adhesive layers of the surface protective sheets was attached to a fixing plate having a sufficient strength (such as an SUS430BA plate) with a double-faced tape.

After a lapse of 30 minutes from the attachment, one of the surface protective sheets whose pressure-sensitive adhesive layers had been attached to each other in advance was peeled with an Instron-type tensile tester (Autograph manufactured by Shimadzu Corporation) under conditions of a tension speed of 300 mm/min and 180° peeling. At this time, a sample where a failure in a portion between the supporting base material and pressure-sensitive adhesive layer of the surface protective sheet on the fixing plate side (anchoring failure) occurred was selected, and a force needed for the failure was defined as an anchoring force (N/20 mm).

In addition, a sample where a failure occurred in a portion except the portion between the supporting base material and pressure-sensitive adhesive layer of the surface protective sheet on the fixing plate side at the time of the peeling was judged as causing no anchoring failure (the sample was described as “−” in Table 1).

### <<Adhesive Residue>>

An acrylic plate (ACRYLITE L manufactured by Mitsubishi Rayon Co., Ltd.), an ABS plate, and an SUS plate (SUS430BA) were used as adherends. It should be noted that the surface of the SUS plate was washed with toluene before its use.

A surface protective sheet was attached to each of the adherends at a linear pressure of 78.5 N/cm and a speed of 300 ram/min, and then the resultant was left to stand at 80° C. for 1 day.

After that, the temperature was returned to room temperature, and then the surface protective sheet was peeled under conditions of a speed of 300 mm/min and 90° peeling. The presence or absence of an adhesive residue on the surface of each of the adherends was observed with the eyes.

∘: The adhesive residue was absent.

x: The adhesive residue was present.

### Example 1

The following materials were prepared as materials for forming a supporting base material.

(Material for forming surface layer (II) out of contact with pressure-sensitive adhesive layer): A mixture of 50 parts of a random polypropylene (NOVATEC PP EG8 manufactured by Japan Polypropylene Corporation) and 50 parts of a low-density polyethylene (NOVATEC LD LJ803 manufactured by Japan Polyethylene Corporation) was prepared.

(Material for forming mechanical property control layer): A block polypropylene (Noblen KS23f8 manufactured by Sumitomo Chemical Co., Ltd.) was prepared.

(Surface layer (I) in contact with pressure-sensitive adhesive layer): A random polypropylene (NOVATEC PP EG8 manufactured by Japan Polypropylene Corporation) was prepared.

The above-mentioned materials for forming the supporting base material were molded by T-die melt co-extrusion. Thus, a supporting base material (1) was obtained. The surface layer (II) out of contact with the pressure-sensitive adhesive layer had a thickness of 8 μm, the mechanical property control layer had a thickness of 40 μm, and the surface layer (I) in contact with the pressure-sensitive adhesive layer had a thickness of 8 μm.

A mixture of 100 parts of a styrene-ethylene-butylene-styrene block copolymer (SEBS) (G1657 manufactured by Kraton Polymers) and 30 parts of a tackifier (ARCON P-125 manufactured by Arakawa Chemical Industries, Ltd.) was separately prepared as a material for forming the pressure-sensitive adhesive layer.

The above-mentioned material for forming the pressure-sensitive adhesive layer was dissolved in a diluent (toluene). The solution was applied to the supporting base material (1), and was then dried. Thus, the pressure-sensitive adhesive layer having a thickness of 5 μm was formed. As a result, a surface protective sheet (1) was obtained.

Table 1 shows the results of the evaluation of the surface protective sheet (1).

### Example 2

A surface protective sheet (2) was obtained in the same manner as in Example 1 except that random polypropylene (PF433M manufactured by SunAllomer Ltd.) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (2).

### Example 3

A surface protective sheet (3) was obtained in the same manner as in Example 1 except that random polypropylene (PC630A manufactured by SunAllomer Ltd.) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (3).

### Example 4

A surface protective sheet (4) was obtained in the same manner as in Example 1 except that random polypropylene (WINTEC WFX6 manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (4).

### Example 5

A surface protective sheet (5) was obtained in the same manner as in Example 1 except that random polypropylene (WINTEC WFX4 manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (5).

### Example 6

A surface protective sheet (6) was obtained in the same manner as in Example 1 except that random polypropylene (WINTEC WSX02 manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (6).

### Example 7

A surface protective sheet (7) was obtained in the same manner as in Example 1 except that random polypropylene (WINTEC WFW4 manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (7).

### Example 8

A surface protective sheet (8) was obtained in the same manner as in Example 1 except that random polypropylene (WELNEX RFG4VA manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (8).

### Comparative Example 1

A surface protective sheet (C1) was obtained in the same manner as in Example 1 except that block polypropylene (NOVATEC PP EC9 manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (C1).

### Comparative Example 2

A surface protective sheet (C2) was obtained in the same manner as in Example 1 except that block polypropylene (NOVATEC PP BC2E manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (C2).

### Comparative Example 3

A surface protective sheet (C3) was obtained in the same manner as in Example 1 except that block polypropylene (NOVATEC PP BC3HF manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (C3).

### Comparative Example 4

A surface protective sheet (C4) was obtained in the same manner as in Example 1 except that homopolypropylene (NOVATEC PP EA9 manufactured by Japan Polypropylene Corporation) was used instead of the random polypropylene (NOVATEC PP EG8 manufactured by Japan Polypropylene Corporation) as a material for forming the surface layer (I) in contact with the pressure-sensitive adhesive layer.

Table 1 shows the results of the evaluation of the surface protective sheet (C4).

### Table 1

TABLE 1

| | | Example | | | | | | |
|---|---|---|---|---|---|---|---|---|
| | | 1 | 2 | 3 | 4 | 5 | 6 | 7 |
| Surface | Trade name | NOVATEC PP EG8 | | | | | | |
| layer (II) | (polypropylene) | | | | | | | |
| | Trade name | NOVATEC LD LJ803 | | | | | | |
| | (low-density | | | | | | | |
| | polyethylene) | | | | | | | |
| | polypropylene/ | 50:50 | | | | | | |
| | low-density | | | | | | | |
| | polyethylene | | | | | | | |
| | Ra2 (um) | 1.0 | | | | | | |
| Mechanical | Trade name | Noblen KS23f8 | | | | | | |
| property | | | | | | | | |
| control | | | | | | | | |
| layer | | | | | | | | |
| Surface | Trade name | NOVATEC | PF433M | PC630A | WINTEC | WINTEC | WINTEC | WINTEC |
| layer (I) | | PP EG8 | | | WFX6 | WFX4 | WSX02 | WFW4 |
| | Polymer | Random polypropylene | | | | | | |
| | primary structure | | | | | | | |
| | Polymerization | Ziegler-Natta | | | Metallocene | | | |
| | catalyst | | | | | | | |
| | MFR | 0.8 | 2 | 7.5 | 2 | 7 | 25 | 7 |
| | (g/10 min.) | | | | | | | |
| | Ra1 (um) | 0.26 | 0.05 | 0.05 | 0.11 | 0.06 | 0.09 | 0.07 |
| Haze (%) | | 63 | 62 | 62 | 62 | 62 | 62 | 62 |
| Anchoring force (N/20 mm) | | 10.8 | — | 11.6 | — | — | 11.0 | 10.8 |
| Adhesive | Acrylic plate | ∘ | ∘ | ∘ | ∘ | ∘ | ∘ | ∘ |
| residue | ABS plate | ∘ | ∘ | ∘ | ∘ | ∘ | ∘ | ∘ |
| | SUS plate | ∘ | ∘ | ∘ | ∘ | ∘ | ∘ | ∘ |

| | | Example | Comparative Example | | | |
|---|---|---|---|---|---|---|
| | | 8 | 1 | 2 | 3 | 4 |
| Surface | Trade name | NOVATEC | NOVATEC PP EG8 | | | |
| layer (II) | (polypropylene) | PP EG8 | | | | |
| | Trade name | NOVATEC | NOVATEC LD LJ803 | | | |
| | (low-density | LD LJ803 | | | | |
| | polyethylene) | | | | | |
| | polypropylene/ | 50:50 | 50:50 | | | |
| | low-density | | | | | |
| | polyethylene | | | | | |
| | Ra2 (um) | 1.0 | 1.0 | | | |
| Mechanical | Trade name | Noblen KS23f8 | Noblen KS23f8 | | | |
| property | | | | | | |
| control | | | | | | |
| layer | | | | | | |
| Surface | Trade name | WELNEX | NOVATEC | NOVATEC | NOVATEC | NOVATEC |
| layer (I) | | RFG4VA | PP EC9 | PP BC2E | PP BC3HF | PP EA9 |
| | Polymer | Random | Block polypropylene | | | Homopoly- |
| | primary structure | polypropylene | | | | propylene |
| | Polymerization | Metallocene | Ziegler-Natta | | | |
| | catalyst | | | | | |
| | MFR | 6 | 0.5 | 16 | 8.5 | 0.5 |
| | (g/10 min.) | | | | | |
| | Ra1 (um) | 0.07 | 0.32 | 0.47 | 0.34 | 0.63 |
| Haze (%) | | 62 | 63 | 65 | 63 | 68 |
| Anchoring force (N/20 mm) | | — | 9.7 | 7.8 | 8.4 | 8.0 |
| Adhesive | Acrylic plate | ∘ | x | x | x | ∘ |
| residue | ABS plate | ∘ | ∘ | x | x | x |
| | SUS plate | ∘ | ∘ | x | x | ∘ |

As can be seen from Table 1, the pressure-sensitive adhesive layer of the surface protective sheet of the present invention has a high anchoring force for the supporting base material, and no adhesive residue occurs upon peeling of the surface protective sheet after its attachment to an adherend. On the other hand, in each of Comparative Examples 1 to 4 where the block polypropylenes and the homopolypropylene are each used as a material for forming the surface layer (I), the anchoring force of the pressure-sensitive adhesive layer for the supporting base material is low as compared with that in each of the examples, and an adhesive residue occurs upon peeling of the surface protective sheet after its attachment to an adherend depending on the kind of the adherend.

The surface protective sheet of the present invention can be preferably used for protecting an adherend such as a metal plate, a resin plate, or a glass plate by being attached to the adherend in various fields of applications for: the production of electronic parts; structures; automobiles; and the like. The surface protective sheet can also be used in, for example, an external appearance-adjusting application, an ornamental application, and a label application. Further, proper selection of the surface layer (II) or the like enables one to suitably use the surface protective sheet as a surface protective sheet for an optical member such as a prism sheet or a surface protective sheet for a coated steel plate or the like.

What is claimed is:

1. A surface protective sheet, comprising:
a supporting base material;
a surface layer (I) as one outermost layer of the supporting base material; and
a pressure-sensitive adhesive layer on the surface layer (I),
wherein:
the pressure-sensitive adhesive layer contains a thermoplastic elastomer; and
the surface layer (I) contains a random polypropylene at a content of more than 50 wt %.

2. A surface protective sheet according to claim 1, wherein the surface layer (I) has an arithmetic average surface roughness Ra1 of 0.5 μm or less.

3. A surface protective sheet according to claim 1, wherein the supporting base material is formed of a structure having two or more layers, and has a surface layer (II) having an arithmetic average surface roughness Ra2 of 0.5 μm to 2.0 μm as an outermost layer on a side opposite to the surface layer (I).

4. A surface protective sheet according to claim 1, wherein the supporting base material is formed of a structure having three or more layers, and has a mechanical property control layer as one intermediate layer.

5. A surface protective sheet according to claim 1, wherein the surface layer (I) has a thickness of 2 μm to 20 μm.

6. A surface protective sheet according to claim 3, wherein the surface layer (II) has a thickness of 2 μm to 20 μm.

7. A surface protective sheet according to claim 1, wherein a content of the thermoplastic elastomer in the pressure-sensitive adhesive layer is 50 wt % or more.

8. A surface protective sheet according to claim 1, wherein the random polypropylene in the surface layer (I) has a melt flow rate of 1 g/10 min to 50 g/10 min.

9. A surface protective sheet according to claim 1, wherein the surface protective sheet has a haze value of 20% to 80%.
